(19) United States
(12) Patent Application Publication
(10) Pub. No.: US 2023/0343921 A1
(43) Pub. Date: Oct. 26, 2023

(54) METHOD AND APPARATUS FOR MANUFACTURING A BATTERY CELL

(71) Applicant: PELLENC ENERGY, PERTUIS (FR)

(72) Inventor: Roger PELLENC, PERTUIS (FR)

(21) Appl. No.: 18/005,085

(22) PCT Filed: Jul. 13, 2021
(86) PCT No.: PCT/IB2021/056298

§ 371 Date: Jan. 11, 2023

(30) Foreign Application Priority Data
Jul. 15, 2020 (FR) 2007389
Sep. 22, 2020 (FR) 2009586

(51) Int. Cl. H01M 4/04; H01M 10/0566; H01M 10/0565; H01M 4/62; H01M 10/04

(52) U.S. Cl. CPC H01M 4/0416; H01M 4/0435; H01M 4/0466; H01M 10/0566; H01M 10/0565; H01M 4/625; H01M 10/0404; H01M 2300/0085; H01M 10/052

(57) ABSTRACT

Disclosed is a method and an apparatus for assembling battery cells, the method including forming electrode layers in a pasty state on electrically conductive supports, these electrode layers being mixtures of ion-conductive liquid electrolytes, monomer or polymer mixtures, and initiators of polymerisation or cross-linking of the monomer or polymer mixtures, the electrode layers being exposed to a radiation initiating their solidification then placed in contact with a separation layer in the liquid state before completion of their respective solidifications, in such a way as to obtain a solid electrolyte battery cell having properties close to those of liquid electrolyte battery cells.

### FIELD OF THE INVENTION

The present invention relates to a method and an apparatus for manufacturing a battery cell, and, by extension, to electric batteries composed of several cells.

Each electric battery cell, or battery, constitutes an electric energy storage device. A battery may be formed by placing battery cells in parallel and/or in series. Each cell comprises a positive electrode, associated with a current collector, and the negative electrode associated with another current collector. The positive and negative electrodes are also designated by “cathode” and “anode.” The current collectors constitute the electrical terminals of the cells.

The electrodes each comprise an electrode material called “active,” capable of interacting with, and retaining, a given ion type, an electronic percolant or electronic conductor additive such as carbon black providing for the passage of electrons from the current collector to the active material of the associated electrode, and, generally, a binder allowing the mechanical hold of the electrodes and the adhesion of the materials on the current collector.

In particular the invention relates to lithium ion, sodium ion or lithium sulfide type cells.

In particular it involves cells combining with the lithium-containing cathode materials such as NMC (Nickel Manganese Cobalt), NCA (Nickel Cobalt Aluminum) or Li2S (lithium sulfide), and anode materials based on carbon, silica and, silicon combined with carbon, transition metals or transition metal alloys or composite materials alloying transition metals and carbon.

More generally, the invention also relates to lithium metal, sodium metal, aluminum metal and the magnesium metal type cells, and apparatus for manufacturing thereof.

The invention has applications for manufacturing thin battery cells with solid electrolyte resulting from solidification of the liquid electrolyte, having a significant surface area. It is in particular suitable for continuous manufacturing of a fixed-width cell with a very large length, according to a roll-to-roll type continuous method. The cells, manufactured according to the invention may be cut apart, combined in series, for example by stacking, and/or in parallel. Without limitation, the invitation also has applications in manufacturing of electric batteries that can be used for electric vehicles, electric tools, portable communication apparatus, drones or even stationary facilities for storing electric energy.

The apparatus for the invention may also be implemented for manufacturing solid electrolyte supercapacitor cells obtained by the solidification of a liquid electrolyte.

### DESCRIPTION OF RELATED ART

Liquid electrolyte battery cells are known.

In these cells, a liquid electrolyte provides ionic conduction between the anode electrode and the cathode electrode and also within each of these electrodes. An electrically insulating separator film is arranged between the anode electrode and the cathode electrode. A direct electrical contact between cathode and anode can be avoided this way while allowing movement of ions.

Liquid electrolyte battery cells are provided with a sealed enclosure forming a reservoir which can contain the electrolyte. Thus, a difficulty in the manufacturing of these cells relates to implementation of a sealed enclosure and sealing thereof.

Another difficulty relates to filling the cells with a liquid electrolyte, which turns out to be a dangerous, inflammable and polluting product.

Other problems come up with liquid electrolyte cells which, other than leakage, have a risk of ignition of the liquid electrolyte when the temperature of the cell rises.

Finally, liquid electrolytes used in cells prove in general to be harmful to the health since electrolytic vapors could affect the respiratory tract. Toxicity of the electrolytes constitutes a disadvantage at the time of manufacturing the cells and also at the time of recycling them.

Solid electrolyte, and more specifically solidified electrolyte, battery cells, which play the same role as the liquid electrolyte in liquid electrolyte battery cells, are also known.

The manufacturing of this type of cell typically comprises the preparation of a positive electrode on a current collector substrate, the preparation of a negative electrode on another current collector substrate and the preparation of the separation layer formed of a solid electrolyte, and then assembly of the layers into a battery cell. The preparation of the various components, and in particular the preparation of the solid (gel or polymer) electrolyte layer may take place by cross-linking or by polymerization of an initially liquid electrolyte under the effect of ultraviolet radiation.

Similarly, the positive and negative electrodes may be obtained either by drying of a solvent from an electrode ink, or by cross-linking of a polymer under ultraviolet radiation or even by heating.

The document EP 3,341,987, for example, can be referred to as an illustration of this type of battery cell.

The document US 2006/0016549 describes a process and apparatus for lamination of an electrode sheet on an electrically conducting support film, which could form a current collector. The lamination takes place by means of heating of the support film and possibly the electrode sheet so as to soften them. After heating, the electrode sheet and the support film are assembled by passing between presser rollers.

The document US 2005/0236732 describes a method and apparatus for extruding a composite film forming a positive electrode, and calendering the film for arriving at an intended thickness. The composite film comprises a mixture of active electrode material, an electronically conducting additive and an ionic conductor polymer electrolyte. In solid electrolyte battery cells, the solid electrolyte layer, which separates the positive and negative electrodes, has a twofold function. The main function is to assure ionic conduction between the electrodes of opposite sign during charging or discharging of the battery cell. Another function is to keep the electrodes of opposite sign apart and thus avoid electronic conduction between the electrodes which could have the consequence of short-circuiting the cell. This second function, electrical insulation, belongs to that of the electrical separating film of the liquid electrolyte cells, where the electrolyte layer is permeable to electrons.

However, any battery has an internal resistance and it is desirable to reduce it as much as possible to increase the yield thereof.

Further, it is also desirable to reduce the manufacturing costs of batteries, while maintaining or increasing the level thereof of reliability and safety in use.

### BRIEF SUMMARY OF THE INVENTION

The object of the invention is to reduce the internal resistance of solid electrolyte batteries and also to provide an economical method for manufacturing solid electrolyte batteries with reduced internal resistance compared to conventional batteries of the same type.

Thus, the invention covers a manufacturing method for an energy storage cell in electrochemical form, comprising the steps of forming a first half-cell, comprising the following steps a1), a2), a3): a1) providing a first electrically conducting support; a2) depositing, on a surface of the first electrically conducting support, a cathode layer in a pasty state, comprising an active cathode material, carbonaceous electrically conducting fillers, a first liquid ion conducting electrolyte mixture, a first monomer or polymer mixture and a first polymerization or cross-linking initiator for the first monomer or polymer mixture; a3) exposing the cathode layer in a pasty state by means of a first radiation suited to the first polymerization or cross-linking initiator for the first monomer mixture, so as to initiate a solidification of the cathode layer; forming a second half-cell, comprising the following steps b1), b2), b3): b1) providing a second electrically conducting support; b2) depositing, on a surface of the second electrically conducting support, an anode layer in a pasty state, comprising an active anode material, carbonaceous electrically conducting fillers, a second liquid ion conducting electrolyte mixture, a second monomer or polymer mixture and a second polymerization or cross-linking initiator for the second monomer or polymer mixture; b3) exposing the anode layer in a pasty state by means of a second radiation suited to the second polymerization or cross-linking initiator for the second monomer mixture, so as to initiate a solidification of the anode layer; implementing at least one of the following steps a4), b4) and c4): a4) depositing and exposing, on the exposed cathode layer before complete solidification of the first exposed electrode layer, a first separation layer formed of a first separation mixture in a liquid state, comprising a first ion conducting separation liquid electrolyte mixture, a first separation monomer or polymer mixture and a first polymerization or cross-linking initiator for the first separation monomer or polymer mixture; b4) depositing and exposing, on the exposed anode layer before complete solidification of the exposed anode layer, a second separation layer formed of a second separation mixture in a liquid state, comprising a second ion conducting separation liquid electrolyte mixture, a second separation monomer or polymer mixture and a second polymerization or cross-linking initiator for the second separation monomer or polymer mixture; c4) depositing and exposing, on an electrically insulating grid film, a third separation layer formed of a third separation mixture in a liquid state, comprising a third ion conducting separation liquid electrolyte mixture, a third separation monomer or polymer mixture and a third polymerization or cross-linking initiator for the third separation monomer or polymer mixture; where the exposures for steps a4), b4), and c4) were implemented by means of third radiations, suited for the polymerization or cross-linking initiators for the respective separation monomer or polymer mixtures and suited for initiating solidification of the first, second and third separation layers; assembling the first half-cell and the second half-cell by interposing between the two half-cells, at least one of the separation layers from steps a4), b4) and c4), where the assembly comprises one of the following steps d1), d2), d3) and d4): d1) bringing the exposed first separation layer into direct contact with the exposed second separation layer; d2) bringing the exposed first separation layer into direct contact with the exposed anode layer; d3) bringing the exposed second separation layer into direct contact with the exposed cathode layer; and d4) enclosing the third exposed separation layer between the exposed cathode layer and the exposed anode layer, in which steps d1), d2), d3) and d4) the respective solidifications of the layers brought into contact are incomplete.

The inventors started from the observation of an imperfect ionic conduction between positive and negative electrodes through the separation layer formed from a solid electrolyte mechanically and electrically separating the positive and negative electrodes from each other and subsequently designated as separation layer.

The inventors also observed insufficient ionic conduction between the active electrode materials, conventionally in sheet form placed in contact with an electrolyte.

Also, a goal of the invention is to propose a manufacturing method for a battery cell improving ionic conduction properties between the electrodes and the separation layer, as well as the interface between the active material and the electrolyte of the electrode layers, but also inside the active material and inside the separation layer.

Thus, a goal of the invention is to get a solid battery cell having ionic conduction performance comparable to liquid electrolyte cells.

The invention thus aims to get a cell with a separation layer comprising a solid electrolyte which has an electronic and ionic conduction quality inside the electrolyte comparable to that of cells using a liquid electrolyte.

The invention also targets improving the ionic conduction from one electrode to the electrode of opposite sign through the separation layer while avoiding any electronic conduction.

The goal of the invention is to propose “all solid” type cells, meaning cells without liquid electrolyte, whose safety, in particular in terms of sealing, ignition risks and health risks, is largely improved.

The safety of the cells covers any time in manufacturing thereof, use thereof, throughout their lifetime, and also in end-of-life for recycling thereof.

The goal of the invention is also to propose a method and apparatus for manufacturing battery cells with which to continuously and automatically manufacture battery cells while reducing the manufacturing costs thereof.

The goal of the invention is also to propose a manufacturing method for battery cells having an improved capacity per unit mass, wherein the electrodes have no binder and in particular no “PVDF” (polyvinylidene fluoride) type binder.

Another goal of the invention is to propose a manufacturing method for batteries in particular by stacking solid electrolyte cells not requiring connection links outside of the cells. Finally, the goal of the invention is to propose an apparatus for manufacturing a solid electrolyte battery cell.

### DETAILED DESCRIPTION OF THE INVENTION

The invention implements a method with which to assure an excellent contact interface between a cathode layer and a separation layer on the one side, and an anode layer and the separation layer on the other, and possibly between sub-layers the combination of which forms the separation layer. Further, excellent ionic conduction is assured in the anode and cathode layers, since the active cathode and anode materials and carbonaceous electrically conducting fillers have excellent contact with the electrolyte of the cathode and anode layers. In fact, during formation of the electrode layers, the fact that the active material and the carbonaceous electrically conducting fillers are dispersed in the ion conducting electrolyte mixtures in the liquid state assures not only a close contact, but also large contact surface areas with the electrolyte, characteristics maintained during solidification of the electrode layers.

The method from the invention may be implemented by forming a separation layer formed of an electrolyte without active material either on only the cathode layer, on only the anode layer, or on the anode layer and on the cathode layer.

In order to distinguish them, the separation layer, when it is deposited on the cathode layer is designated by “first separation layer,” and when it is deposited on the anode layer, it is designated by “second separation layer.”

When the first separation layer and the second separation layer are both present, the assembly of the first half-cell and the second half-cell takes place by placing these two layers into close contact.

When only the first separation layer is formed on the cathode layer of the first half-cell, the assembly of the half-cells takes place by placing the first separation layer in contact with the anode layer of the second half-cell.

Conversely, when only the second separation layer is formed on the anode layer of the second half-cell, the assembly of the half-cells takes place by placing the second separation layer in contact with the cathode layer of the first half-cell.

In all cases, the layers placed in contact for assembly of the half-cells are placed before complete solidification thereof, so as to allow some interpenetration of the material and a close contact between the layers, as described again later.

Unless indicated otherwise, the remainder of the description refers to an embodiment where each of the half-cells comprises an electrolyte surface layer without active material, where this does not prejudge the possibility of selecting only one of the first and the second electrolyte layer without active material.

Further, the separation layer resulting at the end of the manufacturing method extends from the cathode layers to the anode layer and is impermeable to electrons but may have an ionic conductivity.

The first and second support form, due to their electrical conductor characteristic, current collectors for the first and second half-cell respectively. In this method, steps a2 and a3 aim to make a positive electrode (cathode) on the first electrically conducting support. The function of first electrically conducting support is to form a current collector for the battery cell for the positive electrode. It may comprise one or more layers of electrically conducting material. These conducting materials may be selected from metal, conducting polymers, and woven or nonwoven carbon fiber films. Copper, aluminum, stainless steel and nickel, for example, may be listed among the metals that can be used. The same applies to the second electrically conducting support which serves to collect the current for a negative electrode (anode) made in steps b2 and b3. The first conducting support and the second conducting support may in particular be supplied in the form of strips uncoiled from rolls. This aspect is described in more detail in the following.

Just the same, an implementation of the method from a first and a second conducting support in sheet or plate form is not excluded and may constitute an alternative to the roll-to-roll method described below.

Referring to the operations a1 and b1, the cathode layer and the anode layer, respectively containing the active cathode material, for the formation of a positive electrode, and the active anode material, for the formation of a negative electrode, are deposited on the conducting supports in a pasty form, comparable to an ink. This consistency is due to the solid particle content of the cathode and anode layers.

These layers are made up more precisely of mixtures comprising the active electrode material (cathode or anode, as applicable), carbonaceous electrically conducting additives such as carbon black, carbon nanotubes or carbon nanofibers, graphene, or graphene oxide and a solidifiable liquid having ionic conduction properties, such as a mixture comprising an ion conducting liquid electrolyte mix, a monomer or polymer mix and a first polymerization or cross-linking initiator for the monomer or polymer mix. This mixture may be considered as a solidifiable electrolyte mixture or more simply a solidifiable electrolyte. These mixtures—liquid, semiliquid or pasty—which can generically be considered like liquids, allow an excellent cohesion between the constituents thereof, resulting, after solidification thereof by polymerization or cross-linking of the monomer or polymer mixture into solid layers having excellent ionic conduction properties.

It is possible to use solidifiable liquid electrolytes of different compositions for the cathode layer, the anode layer, and the separation layers, in order for example to optimize respective functions of each of the layers.

Alternatively, the same solidifiable liquid electrolyte, apart from additives that it may contain, may be used for all the operations of the method, such that the same solidifiable liquid electrolyte is used to form the cathode layer, anode layer and separation layer.

Using the same solidifiable liquid electrolyte serves to improve compatibility and getting a homogeneous cross-linking between the various layers brought into contact, making adjustments of the manufacturing method easier and reducing production costs.

To be concise, unless otherwise indicated, the remainder of the description deals with this last case, and this single solidifiable liquid electrolyte is designated by “the solidifiable liquid electrolyte.”

The first mixture and the second mixture may be prepared in mixers, and preferably under a neutral atmosphere, which means that the gas or gases making up the neutral atmosphere do not chemically interact with the constituents of the electrodes, and in particular do not react with the active ingredients thereof.

The function of the electrically conducting additives is to improve the conduction of the electrons in the cathode and anode layers. The proportion of electrically conducting additives may preferably be less than 20% by mass of the cathode or anode layer considered. It is for example included between 5 and 20% when it involves carbon black, and included between 1 and 5% when it involves carbon nanotubes, carbon nanofibers or graphene.

Ionic conduction is provided by the electrolyte which may comprise ion conducting salts.

Other than the ionic conduction function thereof within the active material, the electrolyte which goes into the composition of the mixtures intended to form the cathode layer and anode layer, is also involved in attaching these layers to the supports forming current collectors. The electrolyte, still liquid constitutes, by the surface tension thereof, a wetting agent for the first support and the second support and thus improves adhesion of the mixtures comprising the active material for these supports. The result of this, after solidification, is an excellent attachment of the anode and cathode layers on the current collectors.

It is appropriate to indicate that the term “liquid” does not prejudge the viscosity and may serve to designate pasty or semiliquid layers. In particular, the mixtures used to form the cathode and anode layers may have a pasty consistency due to their content of solid elements, whereas the electrolyte without active material and forming the separation layer may be more fluid because it is deposited with a lesser thickness. The qualifying term “liquid” may apply to each of these layers.

Thus, the thickness of the cathode layer and the thickness of the anode layer may comprise between 50 μm and 300 μm and the thickness of the separation layer may comprise between 20 μm and 60 μm.

The electrode layers—cathode and anode—may be made up respectively of a first mixture and a second mixture, each comprising 65 to 80% of electrode active material intended to store and release conducting ions during charging and discharging cycles of the battery, 1 to 20% carbonaceous electrically conducting additives intended to improve the conductivity of the electrons in the layers, and 10 to 50% solidifiable liquid electrolyte, supplying mobile ions and serving as support therefore, where the percentages express proportions by mass of the electrode layers.

The liquid electrolyte, which here is a solidifiable liquid electrolyte, may be made up of a mixture comprising 10 to 30% lithium salts, 50 to 75% solvent such as a carbonate solvent or an ether solvent in which the ions are dissolved, 10 to 30% of a monomer and 0.1 to 5% of a photoinitiator intended to cross-link or polymerize the monomer so as to solidify the electrode layers, where the percentages represent proportions by weight of the solidifiable liquid electrolyte.

More generally, in this description, the lithium salts could be replaced generically by battery electrolyte alkaline salts, which comprise in particular lithium salts and sodium salts.

A monomer may optionally be replaced by a monomer mixture made up of several distinct monomers in order for example to obtain a viscosity better suited to the intended manufacturing method.

The solidifiable liquid electrolyte which goes into the composition of the first mixture and the second mixture forming the cathode and anode layers may comprise, for example, an electrolyte gel/polymer with a lithium bis(trifluoromethane)sulfonimide (LiTFSI) type lithium salt, for example lithium bis(trifluoromethanesulfonyl)imide: N-butyl-N-methylpyrrolidiniumbis (fluorosulfonyl) imide sold by Solvionic company, or a standard liquid electrolyte with carbonates (1M LiPF6 EC/DMC or EC/DEC).

Other combinations using, for example, a lithium salt combined with carbonate solvents, or ethers, or ionic liquids, or ion conducting polymers or ion conducting glasses and ceramics, are not excluded.

The monomer may be, for example, trimethylolpropane ethoxylate triacrylate (ETPTA4).

The photoinitiator of the solidifiable liquid electrolyte serves, under the effect of exposure to radiation, and in particular to light radiation, to initiate polymerization or cross-linking of monomers or polymers, respectively, leading to solidification of layers comprising solidifiable liquid electrolyte by formation of a polymer gel electrolyte. In the case of polymerization of monomers, it involves radical polymerization.

It involves, for example, HMPP (2-hydroxy-2-methylpropiophenone) type photoinitiator, such as sold under the name Darocur 1173, or even 2,2-dimethoxy-2-phenylacetophenone (DMPA).

Other photoinitiators are not excluded.

The first mixture, used for the cathode layer, may comprise a powder-form cathode active material of NMC (Nickel Manganese Cobalt), NCA (Nickel Cobalt Aluminum), sulfur or Li2S.

The solidifiable liquid electrolyte is included in the first mixture at a portion of 10% to 50% by volume of the mixture, for example 20%.

The carbonaceous electrically conducting fillers whose proportion may be included between 5% and 15% by volume of the mixture and may comprise in particular carbon nanotubes, carbon nanofibers and/or carbon black.

The active powders and the electrically conducting fillers are mixed with the solidifiable liquid electrolyte.

The second mixture, used for the anode layer, may comprise, for example, the solidifiable liquid electrolyte, and anode active material of graphite particles, LTO (lithium titanate) or silicon particles with or without lithium. These particles may possibly be combined with carbonaceous particles, such as nanotubes or carbon nanofibers.

The solidifiable liquid electrolyte is included in the second mixture at a portion of 10% to 50% by volume of the mixture, for example 20%.

The carbonaceous electrically conducting fillers whose proportion may be included between 5% and 15% by volume of the second mixture and may comprise in particular carbon nanotubes, carbon nanofibers and/or carbon black.

The active powders and the electrically conducting fillers are mixed with the solidifiable liquid electrolyte.

It is appropriate to specify that the method from the invention may be reversed as it relates to the manufacturing of the positive and negative electrodes of the cell.

In other words, the step a2, may be implemented with an active anode material for making a half-cell with a negative electrode and the step b2 may be implemented with an active cathode material for making a half-cell with a positive electrode.

Advantageously, and because of the presence of an electrolyte which can be solidified in the mixtures forming the cathode and anode layers, these electrodes may be formed without use of a binder forming additive for the mechanical strength of the electrodes. In particular, they do not comprise PVDF (polyvinylidene fluoride) type binder generally used ordinarily in conventional batteries. This reduces the weight thereof and increases the capacity per unit mass of a storage device using these electrodes, meaning the electric energy which could be stored per unit mass. A weight improvement of order 10% may be obtained in comparison with cells whose electrodes comprise a PVDF type binder, for the same electric charge capacity.

Depositing the layers of mixtures on the electrically conducting substrates takes place when the mixtures are liquid or, more specifically, pasty.

The layers can be deposited continuously on passing strips of electrically conducting substrate when it is done in particular by means of depositing heads of surface coating head type (slot die coating). It should be specified that other coating techniques, using extrusion heads, are not excluded.

Solidification of the cathode and anode layers is initiated by exposing them to an initiator radiation to which the photoinitiator of the solidifiable liquid electrolyte is sensitive.

The radiation may be light radiation. It involves, for example, ultraviolet radiation (UV) produced by a UV lamp, UV light emitting diodes or a UV laser beam. The light radiation may also be radiation in the visible or near-infrared spectrum. It should be indicated that the function of the light radiation is initiation of the solidification and not heating. A non-heating radiation is in fact preferred for avoiding any risk of thermal alteration of the solidifiable liquid electrolyte.

The wavelength of the selected radiation is a function of the photoinitiator contained in the solidifiable liquid electrolyte used in the mixture forming the anode or cathode layer.

In order to assure good penetration of the radiation in the material before being solidified, it may preferably have a wavelength included between 100 nm and 1600 nm.

The solidification may also be initiated by means of a radiation in the form of an electron beam with high energy penetration extending up to 300 keV, preferably a dose less than 100 kGray in order to avoid breakdown of the constituents of the layers, the monomers in particular.

It is understood that the solidification speed depends on the composition of the mixtures considered, the dose of exposure to radiation initiating this solidification, such that adjustments to these parameters must naturally be done in order to assure that the layers are effectively brought into contact before respective complete solidification thereof.

The cathode layer is covered with a first solidifiable liquid electrolyte layer, without active anode or cathode material. Similarly, the anode layer is covered with a second solidifiable liquid electrolyte layer, without active anode or cathode material.

As previously indicated, it is also possible to only cover one of the cathode layers and the anode layer with a liquid electrolyte layer that is without active material and solidifiable.

These liquid electrolyte layers are exposed to radiation initiating solidification thereof, included in the steps a4 and b4 previously mentioned. The electrolyte layers may be deposited by means of depositing heads comparable to those used for depositing the cathode layer and the anode layer on the first support and the second support.

The features and sizing of the depositing heads may be adapted to the more or less fluid properties of the materials deposited. The electrolyte without active material turns out in fact be more fluid than the mixtures used for forming the cathode layer and the anode layer, because of the absence of active material and also because of the absence of carbonaceous particles which may be found in the electrode layers (cathode and possibly anode). It is possible, as needed, to adjust the fluidity of the electrolyte without active material, by making it more pasty, by means of correcting additives such as fluidity adjusting inorganic fillers.

Importantly, depositing the first layer of electrolyte without active material and/or the second layer of electrolyte without active material takes place respectively after initiation of the solidification of the cathode layer and the anode layer, but before complete solidification thereof.

This feature improves a close contact and a perfect attachment of the liquid electrolyte layers without active material onto the underlying cathode and anode layers, comprising the active material.

Hence, the quality of the contact between these layers serves to improve, in the completed battery cell, ionic conduction between the electrodes and the separation layer formed by the liquid electrolyte layers formed thereon, during charging or discharging operations of the battery.

The method from the invention allows some molecular interpenetration at the interfaces between the electrode layers and the separation layer assuring continuity of the material without either barrier or interface.

This results in improvements in terms of reduction of the internal resistance, charging and discharging speed, and also charging capacity of the electric energy storage devices using the cells.

Optionally, the solidifiable liquid electrolyte used for forming the first and second separation layers may be the same as that which goes into the makeup of the first mixture and the second mixture comprising the active material and used for forming the cathode and anode layers.

In fact, using the same solidifiable liquid electrolyte makes it easier to get a very good continuity of the material between successive layers.

In that way, the solidifiable liquid electrolyte for the cathode layer, the solidifiable liquid electrolyte for the anode layer, the solidifiable liquid electrolyte for the first separation electrolyte layer and the solidifiable liquid electrolyte for the second separation layer may be identical and preferably are identical.

The use of identical liquid electrolytes does not prejudge the possible addition in the various layers (anode layer, cathode layer, separation layer) of adjuvants that are different in nature or proportion, such as thickeners or fluidifiers or even electrically conducting nanomaterials as previously mentioned which may enter into the composition of the cathode layer or the anode layer. These adjuvants may be different, or may be present in different quantities, depending on the uses of the electrolyte in the various layers and according to the rheological constraints on formation of the layers.

In particular, the first and second separation layers are preferably formed of a liquid electrolyte without active material and without any electrically/electronically conducting additive in order to avoid a self-discharge risk between electrodes in the battery cell of opposite sign when they are assembled.

The first and second support, provided with layers of mixture comprising active material and layers of electrolyte without active material, constitute half-cells which are assembled in order to form a battery cell.

The assembly, which accompanies placing the first and second electrolyte layer without active material into contact, is also done after initiation of the solidification of the electrolyte, upon beginning of solidification thereof and in any case before complete solidification thereof.

Here again, this measure improves a close contact and a perfect attachment of the electrolyte layers without active material.

With this measure, continuity of the ionic conduction through the electrolyte layers from one electrode to another can be assured in the final cell during charging and discharging cycles.

Placing the first electrolyte layer without active material and the second electrolyte layer without active material into contact is preferably a placement in direct contact.

As a variant, the method may however comprise placing an additional electrically insulating grid separator film between the electrolyte layers without active material or between an electrolyte layer without active material and one of the anode layer and the cathode layer, during assembly of the first half-cell and the second half-cell. In this case, placing these layers into contact is done through this film.

In particular, an electrically insulating grid separating film of a polymer, having the shape of a net with a coarse mesh, with a 2 to 4 mm step, may be inserted between the first and second electrolyte layer without active material. The separator may be soaked with liquid electrolyte which may be solidified and may be exposed to a radiation initiating the solidification of the liquid electrolyte just before being sandwiched between the half-cells, during assembly thereof. In this particular embodiment, it involves the same liquid electrolyte, without electrode active material and without carbonaceous fillers, whether used for implementation of liquid electrolyte layers without active material covering the cathode and anode layers.

Whether the grid separator film is or is not soaked in advance, the electrolyte without active material, still liquid, which is located on both sides of the screen separator film may pass through the grilled separator film. This allows interpenetration of the electrolyte layers without active material through the grid separator.

The interpenetration of the layers of electrolyte without active material is enhanced by passing the half-cells between a pair of rollers implementing the assembly thereof.

Depositing of the electrolyte layers without active material before complete solidification of the layers of mixture comprising the active material and placing the electrolyte layers in contact before solidification thereof allows completion of the solidification after assembly of the cell. As previously indicated, some molecular interpenetration of the successive layers of the battery cell and a continuity of the material results therefrom. With these measures, an excellent ionic conduction between the various layers can be obtained during charging and discharging of the resulting battery cell. A short circuit between the anode and cathode layers can also be avoided this way.

Both the steps a1, a2, a3 and a4 and also the steps b1, b2, b3 and b4 can be done concomitantly. While it isn't indispensable that the steps of forming the two half-cells are perfectly synchronized, they are however done in a sufficiently short passage of time so as to allow the association of the layers before complete solidification thereof.

In this respect it may be noted that the solidification may be completed in a few seconds after initiation thereof, such that the concomitant nature of the steps extends over seconds.

Advantageously, the method may further comprise:
sizing of the thickness of the cathode layer, respectively of the anode layer, before depositing the first electrolyte layer without active material, respectively before depositing the second electrolyte layer without active material; and/or
sizing of the thickness of the first electrolyte layer without active material and of the second electrolyte layer without active material before assembly of the half-cells.

Sizing of the layers serves to make the thickness thereof uniform over the entire extent of the supports and serves to improve the electrical properties of the final cell over the entire extent thereof. Further, the sizing, when it is done by passing the half-cells during manufacturing between sizing rollers, serves to compress the layers and to complete the penetration of the electrolyte into the active material. Possible undesired porosities can also be resorbed this way.

It is understood that the sizing is not necessary to a good-quality contact between the not-yet solidified layers, but it may serve to achieve further quality and uniformity.

The sizing rollers may thus also constitute a rolling mill. The rollers may be heating rollers with which to activate the solidification of the layers.

According to a preferred embodiment of the method, the first support and the second support may respectively be a first support strip and a second support strip.

In this case: supplying the first support and supplying second support may respectively comprise uncoiling of the first support strip and uncoiling of the second support strip respectively from a first uncoiling roller and a second uncoiling roller.

All of the operations may take place according to a method called roll-to-roll between the uncoiling rollers and a coiling roller.

In particular, depositing the cathode layer, and depositing the anode layer may take place continuously by passage of the first strip and the second strip respectively in front of a first depositing head for the first mixture and a second depositing head for the second mixture.

Similarly, depositing the first electrolyte layer without active material and depositing the second electrolyte layer without active material may take place continuously by passage of the first strip and the second strip respectively in front of a third electrolyte depositing head and in front of a fourth electrolyte depositing head.

The organization of the depositing heads and manufacturing apparatus and the layout of modules corresponding to the various operations of the method are subsequently described.

As previously discussed, the depositing heads may be slot-extrusion heads capable of depositing respectively the various layers of material all over the width of the strip as it passes along the strip in front of the depositing heads. At the moment of depositing the various layers, the material coming from the depositing heads is liquid with a more or less fluid consistency.

The depositing heads may also be heads such as commonly used in machines for depositing active material for implementing lithium-ion batteries.

The use of the terms “deposit” and “depositing head” do not prejudge the depositing technique. These terms are understood as encompassing the function of providing material on the supports but also the function of coating the support meaning the distribution of the material on the surface of the support on which it is deposited.

Further, and according to a specific possibility for implementation of the method, exposing the cathode layer and exposing the anode layer may take place by passage respectively of the first strip and the second strip respectively in front of at least one first source of radiation and at least one second source of radiation.

Further, exposing the first separation layer and exposing the second separation layer may take place by passage respectively of the first strip and of the second strip in front of a third radiation source and a fourth radiation source.

Exposing the aforementioned layers is understood as exposure thereof to radiation suited to the photoinitiator contained respectively in the electrolyte of the first mixture serving to manufacture the cathode layer, in the electrolyte of the second mixture serving to manufacture the anode layer and/or in the electrolyte without active material, and serving to initiate the solidification of these layers by polymerization and/or cross-linking.

As previously mentioned, the radiation sources may be lamps, LEDs, but also laser sources or electronic sources capable of emitting electron beams sweeping the materials to be solidified. And may involve sources emitting in the ultraviolet spectrum, but also in the visible and infrared spectrum.

The use of infrared radiation and photoinitiators sensitive in this spectrum allow a better penetration of the radiation into the material.

The order and sequence of the operations and the method may be set by the disposition of the material depositing heads and the radiation sources along the paths made by the first support strip and the second support strip between the uncoiling rollers and presser rollers assembling the half-cells formed on the first support strip and the second support strip.

When the first support and the second support are respectively a first support strip and a second support strip, the sizing of the thickness of the cathode layer, respectively the sizing of the anode layer, may take place by passage of the first support strip, provided with the cathode layer respectively of the second support strip provided with the anode layer through a first pair of sizing rollers and a second pair of sizing rollers. It is appropriate to specify that the thickness of the cathode layer and the thickness of the anode layer are not identical but may be a function of each other. Also, the sizing rollers may be driven by a control computer so as to control the respective thickness of the layers, while considering the thickness of the support bands which make up the current collectors.

Further, the sizing of the thickness of the first electrolyte layer without active material and the second electrolyte layer without active material may take place by passage of the first half-cell, respectively of the second half-cell, through a third pair of sizing rollers and a fourth pair of sizing rollers.

The cell resulting from assembly of the two half-cells constitutes an energy storage device. Cells in strips, with large dimensions, in particular large length, with a nearly unlimited energy storage capacity can result from roll-to-roll manufacturing in the manner described. Such cells may be useful for equipping stationary electric energy storage facilities.

It is however possible to get smaller cells simply by cutting cells. In fact, the method may comprise, subsequent to assembly of the half-cells, an operation of formatting the cell comprising cutting of the battery cell into formatted cells. The cutting passes through and extends perpendicularly to the first support and the second support. It may be done on laser cutting tables similar to those used for cutting fabrics. Laser cutting allows a cut quality with local melting of the materials and serves to avoid any risk of electrical short-circuit, in particular between the current collectors. A plurality of formatted cells may thus be obtained from one single large dimension cell.

Since the cell does not have a liquid electrolyte, any risk of electrolyte flow is set aside and the cut then does not demand any particular precaution concerning the electrolyte.

The formatted cells finally obtained may preferably be cells with rectangular principal surfaces and with rounded corners so as to avoid any fragility of the corners.

Finally, the method may comprise placing a protective coating of electrically insulating material over at least one side edge of the formatted battery cell. Protection of the side edge(s) resulting from cutting of the cell into formatted cells is not of itself indispensable to the operation of the cells. It is however desirable because of the very small thickness of the cells, of order of a few hundred microns, in order to avoid any risk of an unexpected short-circuit between the current collectors. The insulating material on the cut side-edges may also be placed in a liquid form and solidified by exposure to radiation. In this case, it involves a photo-polymerizable electrical insulator.

Finally, the side edges of the formatted battery cell may be protected by placement on the side-edges of an adhesive ribbon whose width corresponds to the thickness of the cell or several stacked cells.

The invention also relates to a manufacturing method for a battery. The method comprises manufacturing a plurality of formatted battery cells in the manner previously described, and the formation of a stack of formatted battery cells, where the formation of the stack comprises placing a free conducting surface of the first support of a formatted battery cell into contact with a free conducting surface of the second support of a following formatted battery cell of the stack.

The first support of a cell forms a current collector and has a surface in contact with the cathode layer and an opposite electrically conducting free surface. In the same way, the second support of a cell also forms a current collector and has a surface in contact with the anode layer and an opposite electrically conducting free surface. Here, “free surface” is understood to mean a current collector support surface which does not have an electrode.

In the battery, the free surfaces of current collectors serve as connectors for electrical interconnection of the cells.

The battery may comprise a stack of a plurality of formatted cells placed in series with alternating half-cells with layers of positive and negative active material, meaning with alternating cathodes and anodes. The fact of stacking the formatted cells serves to directly implement interconnection thereof by placing the free surfaces of the current collector forming supports in physical and electrical contact.

Other arrangements for placing formatted cells in series and/or in parallel for implementing storage batteries are of course not excluded. When the cells are not stacked, additional electrical conductors may be provided for electrically connecting the current collectors of the cells according to an intended interconnection scheme.

The invention finally relates to apparatus suitable for forming battery cells such as previously described. The apparatus comprises:
a first manufacturing line for manufacturing a first half-cell;
a second manufacturing line for manufacturing a second half-cell;
a pair of assembly rollers for the assembly of the first half-cell formed on the first manufacturing line and a second half-cell formed on the second manufacturing line; and
a battery-cell coiling roller placed downstream from the pair of assembly rollers.

The coiling roller, which may be a driving roller, is intended to coil a completed battery formed of one half-cell coming from the first manufacturing line and a second half-cell coming from the second manufacturing line.

First manufacturing line and second manufacturing line are understood to mean homologous installations for apparatus, similar to each other and dedicated to simultaneous manufacturing of two half-cells. The manufacturing lines come together near the assembly rollers where the two half-cells are assembled.

In particular, at least one of the first manufacturing line and the second manufacturing line may comprise:

an uncoiling roller suitable for uncoiling a support strip and, in order between the uncoiling roller and the pair of assembly rollers:
a first coating module suitable for forming a cathode layer, respectively an anode layer;
a first rolling module;
a second coating module suitable for forming an electrolyte layer without active material; and
a second rolling module.

Each module comprises the necessary members for executing one or more operations of the manufacturing method.

The various modules making up the manufacturing lines may be moved one relatively the other, and relative to the assembly roller pair so as to be able to respectively adjust the distance separating the consecutive modules.

The modification and the control of this distance serves to set the time passing between the operations done by each module, knowing that the support strips, and the half-cells formed on the support strips move, at a fixed passage speed, from one module to the other from roller to roller between the uncoiling rollers and the coiling roller.

It is thus possible to adjust the time passing between both depositing and exposing the layer to radiation and also rolling thereof. It is also possible to adjust the time passing between depositing and/or exposing the layers to radiation initiating solidification of these layers and the assembly of the half-cells.

The first coating module and the second coating module each comprise a cathode layer depositing head, respectively anode layer, and at least one radiation source associated with the depositing head.

The first and second rolling module comprise respectively a pair of sizing rollers and a thickness sensor associated respectively with the pair of sizing rollers. The rolling modules have multiple functions. A first function is to set the thickness of the deposited layers. Another function is to make the thickness of the layers uniform. Yet another function, in particular for the second rolling module, is to press the electrolyte layer without active material against the underlying cathode or anode layer in order to improve the welding of the layers. Finally, when the sizing rollers apply heat, a function may be to increase the solidification speed of the layers.

The thickness sensor associated with the sizing rollers of the rolling modules issues a signal which may be combined with other thickness sensors of other modules or a thickness sensor of the support strip arranged after the uncoiling rollers.

The combination of all of these signals in a calculation unit serves to determine the thickness of the various layers, or of the half-cells during manufacturing thereof, and to adjust, as needed, a spacing of the sizing rollers so as to achieve predetermined setting values.

The positioning and spacing of the modules on the trajectory of the half-cells combined with the control of the passage speed of the support bands serves to finely control the time interval separating two distinct operations and thus the degree of solidification of the layers deposited in liquid or pasty form before subsequent operations in the manufacturing of the cell.

In particular, it is thus possible to control the time interval separating (i) exposing an initially pasty electrode layer to UV radiation or an electron beam initiating solidification thereof, and (ii) bringing this layer into contact with the other layer, like for example during depositing a solidifiable liquid electrolyte layer intended to form a separation layer on an exposed anode or cathode layer. Control of the time interval serves to assure that the contact between the two layers will initially be done when they are in liquid or pasty states, which will allow a close contact between these layers.

The same principle applies, after exposure, to bringing the two electrolyte layers without active material into contact in order to form together a separation layer inserted between a cathode layer and an anode layer.

It is understood that the time intervals considered correspond to the application of a manufacturing step at a given location of a support strip and that the speed of passage corresponds to the speed of displacement of the given location along a path going from one module to another corresponding respectively to different operations of the manufacturing method of a battery. In that way, the time interval At separating the application of two steps of the manufacturing method is estimated by At=d/V where d is the distance traveled by a support strip between two modules for implementation of these two steps of the manufacturing method and V is the linear speed of passage of the support strip. Thus, in a continuous manufacturing method such as the one shown by FIG. 1, stating that two operations are applied successively is understood in the sense where these two operations are applied successively at one given location of a support, a strip or a film while passing.

The radiation sources for the coating modules may, as needed, be broken up into several sources in order to better expose the material to be solidified. The source of radiation can also be provided equivalent to one source having an opening of 200 mm in the direction of passage of the layers, made up of a set of five separate radiation sources each having an outlet opening extending over 40 mm in the direction of passage of the layers.

The radiation sources are, for example, sources of ultraviolet, near infrared or visible radiation and more generally sources compatible with photoinitiators present in the liquid materials needing to be solidified. Additionally, an adjustment of the radiation emitted by the sources may be provided in order to adjust the intensity thereof as a function of parameters such as the thickness of the layers, the composition thereof and the density thereof, the speed of passage of the support strips/half-cells in front of the modules, the separation of the modules, etc.

In particular, since the carbonaceous fillers tend to stop UV and electronic radiation, an increase in the proportion of carbonaceous fillers in the layers therefore imposes an increase of the exposure doses in order to correctly initiate the solidification, where the doses are controlled by the power, number and surface areas irradiated by the sources, and also by the speed of passage of the supports, commanded by a driver unit during roll-to-roll manufacturing.

Adequate speeds of passage are 1 to 10 m/m in in the case of UV radiation exposure and from 3 to 30 m/min in the case of an electron beam exposure, which is more powerful and penetrating than UV radiation.

Further, the apparatus may comprise an edge-cutting tool. It may be arranged respectively between the second rolling module of each manufacturing line and the pair of assembly rollers. The edge-cutting tool may also be arranged after the pair of assembly rollers. Each cutting tool may be provided with two counter-rotating blades with which to simultaneously cut two opposite lateral edges from the passing strips. Cutting serves to set the width of the two half-cells before assembly thereof.

According to a variant, the edge-cutting tools with blades may be replaced by apparatus cutting by laser beam.

The two manufacturing lines, used respectively for manufacturing of the first half-cell and for manufacturing the second half-cell, may be brought together in a single machine with a synchronized control of the forward movement of the strips.

According to an advantageous embodiment, the coiling roller may be a driving roller. It is considered that the coiling roller is a driving roller when the coiling of the battery cell on the coiling roller is used to exert sufficient traction forces on the battery cell and the components thereof for causing the uncoiling of the strips from the uncoiling rollers, and the forward movement from the uncoiling rollers to the coiling roller of the strips and half-cells formed from the strips. In particular, the forward movement of the strips may be synchronized by the use of a driving coiling roller.

The uncoiling rollers may be rollers with brakes. The use of rollers with brakes, in particular in conjunction with a driving coiling roller, serves to assure a specific tension of the strips and half-cells, and serves to avoid jerks in the uncoiling thereof. The braking of the uncoiling rollers may be braking by friction or electromagnetic braking.

Other members, such as rolling modules or coating modules may also be synchronized with the forward movement of the strips by means of the central driver unit.

The central driver unit may comprise, for example, a dedicated electronic driver circuit, configured for controlling the various members of the apparatus. In particular, the apparatus may comprise a driver unit for at least one among the coiling roller, the first coating module, the second coating module, the first rolling module and the second rolling module. The driver unit may be configured for controlling driving motors in the components or a flow rate in the coating modules. The driver unit may also be used for controlling the intensity of braking of the uncoiling rollers, so as to control the tension in the support strips.

The driver unit may receive the signal from one or more rotational speed sensors associated with one or more rollers in the manufacturing line. These signals may be used by the driver unit in order to determine the passage speed of the strips and half-cells. The signals may also be used for controlling the braking of the uncoiling rollers and/or the drive motor of the coiling roller, so as to set a constant passage speed and constant tension for the strips and the half-cells.

As previously discussed, the apparatus from the invention is suited for implementing solid electrolyte battery cells resulting from solidification of the liquid electrolyte. It also turns out to be suitable for implementing large surface area supercapacitor cells with solid electrolyte resulting from solidification of the liquid electrolyte, according to a roll-to-roll type method.

Just as battery cells may be connected in series or in parallel to form storage batteries, supercapacitor cells may be connected in series or in parallel to form supercapacitor batteries.

Other characteristics and advantages of the invention will appear from the following description with reference to the drawings in the figures. This description is given for illustration and without limitation.

### BRIEF DESCRIPTION OF THE DRAWINGS

FIG. 1 is a schematic representation of various members of the manufacturing apparatus for a cell conforming to the invention. It also indicates the various steps of a manufacturing method for the cell.

FIG. 2 is a schematic representation of a manufacturing line for a manufacturing apparatus for cells comparable to those from FIG. 1 and shows an organization into modules of the members of the apparatus.

FIG. 3 is a schematic view along a principal surface of a formatted battery cell manufactured conforming to the invention.

FIG. 4 is a schematic section of a part of a stack of manufactured formatted cells conforming to the invention and making up a storage battery.

The figures are shown at arbitrary scale.

### DETAILED DESCRIPTION OF THE INVENTION

In the following description, identical, similar or equivalent parts from different figures are referenced with the same reference sign so as to be able to refer from one figure to another.

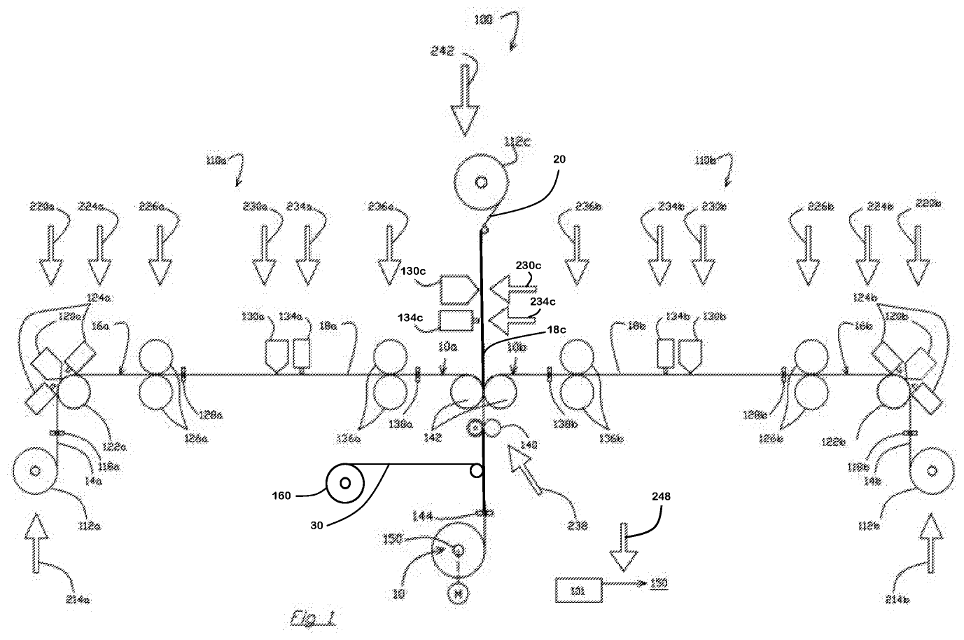

FIG. 1 shows apparatus 100 for manufacturing a battery cell 10 conforming to the invention.

The apparatus 100 is provided with two manufacturing lines 110a, 110b, comprising the same members and which are intended to simultaneously form two half-cells 10a, 10b. The manufacturing lines 110a, 110b come together in a pair of assembly rollers 142 intended to form a battery cell 10 from half cells 10a, 10b. The two manufacturing lines 110a, 110b are configured for forming respectively a half-cell 10a with a positive electrode (cathode) and a half-cell 10b with a negative electrode (anode).

However, the choice of forming a half-cell with a positive or negative electrode does not depend on the apparatus but on the materials used, such that the nature of the half-cell made, with a positive or negative electrode, does not depend on the manufacturing line. It would therefore be possible to implement a half-cell with a positive electrode on the second manufacturing line 110b and a cell with a negative electrode of the first manufacturing line 110a.

Each manufacturing line 110a, 110b comprises an uncoiling roller intended to provide an electrically conducting support serving to collect current from the half-cell in question.

A first uncoiling roller 112a thus delivers a first support strip 14a and a second uncoiling roller 112b delivers a second support strip 14b. The operation supplying a first support 14a and supplying a second support 14b are symbolically shown by arrows, with references 214a, 214b respectively.

For simplification, the first support and the second support, and also the strips that form them respectively, are referenced with the same reference signs 14a, 14b. The support strips 14a, 14b are intended to form the current collectors of the battery cell 10. They may be metal films, for example copper, aluminum, stainless steel, nickel, and also conducting polymer films, webs of conducting fibers, or may comprise several layers of material providing functions of mechanical strength and electrical conduction. The thickness of the support strips may be of order 10 to 200 μm.

The strips may be long, for example, several hundreds of meters. It is not limited by the size of the rollers. Further, in the implementation example described, the width of the support strips is 1200 mm. Other widths, larger or smaller may be selected.

Downstream from the uncoiling rollers 112a, 112b each manufacturing line may comprise a set of return idlers, not shown, serving to control the tension of the support strip 14a, 14b delivered by the roller, and also a thickness sensor 118a, 118b.

Other conveyor rollers, not shown, may be provided for supporting the support strips along the manufacturing line.

Conveyor tables, covered with stainless steel or PVC type polymer sheets, may also be provided for supporting the support strips.

The support strips 14a, 14b respectively join a first depositing head 120a and a second depositing head 120b respectively of the first and second manufacturing line.

These depositing heads are respectively supplied with a first mixture comprising a cathode active material, carbonaceous electrically conducting fillers, an electrolyte in liquid state and with a second mixture comprising an anode active material, carbonaceous electrically conducting fillers and an electrolyte in liquid state.

Also, as the first support strip 14a passes in front of the first depositing head 120a and the second support strip 14b passes in front of the second depositing head 120b, a first layer of first mixture comprising the cathode active material is deposited in step on the first support strip 14a: this is the cathode layer 16a.

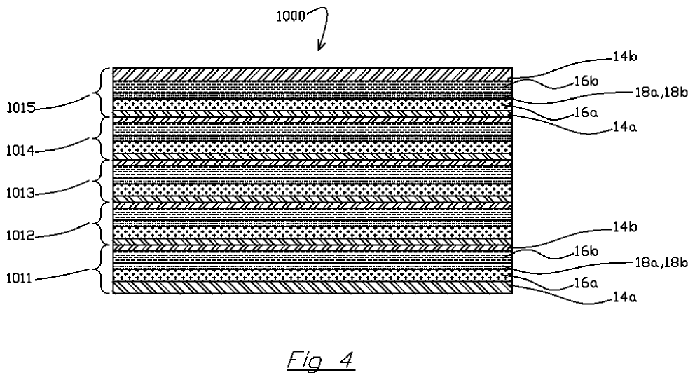

In the same way, a second layer of second mixture comprising the anode active material is deposited in step on the second support strip 14b: this is the anode layer 16b. The layers are not shown in detail in FIG. 1, but can be seen on FIG. 4.

It can be noted that a return idler for strip 122a, 122b faces respectively each depositing head 120a, 120b so as to guarantee a good hold of the support strip 14a, 14b at the time of coating thereof.

The first mixture and the second mixture, which form the cathode and anode layers, leave the depositing heads with a pasty consistency. In addition to active material and possible carbonaceous electrically conducting fillers previously mentioned, they each comprise a liquid state electrolyte which could be solidified.

The thickness of the cathode layer and the thickness of the anode layer may be of order 50 to 300 μm.

Operations of depositing the cathode layer and the anode layer are symbolically indicated by arrows 220a, 220b. The depositing may be done over the full width of the support strips. However, in the example described, the depositing is limited to a width of 1160 mm, while leaving the edges of the strips 14a, 14b free.

In this way, a possible risk of overflow of liquid mixture onto the lateral edges of the strips can be avoided.

On both sides of the first depositing head 120a, first UV radiation sources 124a are found in order to apply radiation to the cathode layer 16a in order to initiate solidification of this layer. In the implementation example from FIG. 1, it involves separated radiation sources with which to expose both surfaces the cathode layer 16a.

The solidification of the layers 16a is due to the solidification of the solidifiable liquid electrolyte that it contains. The electrolyte is in fact provided with a photoinitiator compatible with the radiation from the first radiation sources 124a.

Similarly, on the second manufacturing line 110b second UV radiation sources 124b are arranged on both sides of the second depositing head 120b in order to initiate solidification of the anode layer 16b.

Operations of exposing cathode layer 16a and anode layer 16b to radiation initiating solidification thereof are indicated by arrows 224a and 224b.

Interestingly, in the implementation example described, it may be noted that the irradiation of the layers takes place at the same moment as depositing thereof onto the support strips or immediately after this deposit.

Exposure after depositing is also conceivable, but it does not allow exposure on both surfaces of the deposited layers.

After these operations, the strips from the two manufacturing lines 110a, 110b pass respectively between a first pair of sizing rollers 126a and a second pair of sizing rollers 126b.

Strips provided with the layer thereof containing the active electrode material, meaning respectively the cathode layer and the anode layer, undergo calendering aiming to size the thickness of the mixture layers and avoid porosities.

The thickness of the sheets provided with the electrode layer thereof is measured at the output from the sizing rollers by means of thickness sensors 128a, 128b. The thickness sensors are, for example, triangulated light beam sensors.

By differentiation of the measurements made with the thickness sensors 128a, 128b at the outlet of the sizing rollers and the measurements made by the thickness sensors 118a, 118b at the outlet of the uncoiling rollers 112a, 112b, it is possible to know the thickness of the mixture layers.

This thickness may be compared to a preplanned thickness in order to perform a control coupled to the separation of the pairs of sizing rollers 126a, 126b and the depositing heads 120a, 120b.

The thickness of the layer forming the positive electrode (cathode) and also the thickness of the layer forming the negative electrode may be included between 60 and 300 μm.

Operations of calibrating the thickness of the cathode layer 16a and the anode layer 16b are indicated by the arrows 226a, 226b.

After this first thickness sizing, the support strips 14a, 14b provided with cathode 16a and anode 16b layers comprising active electrode material, pass respectively in front of a third depositing head 130a and a fourth depositing head 130b. The third depositing head 130a is part of the first manufacturing line 110a fourth depositing head 130b is part of the second manufacturing line 110b. These depositing heads respectively deposit a first separation layer 18a in the form of an electrolyte without active material onto the cathode layer 16a of the first support strip 14a and a second separation layer 18b in the form of an electrolyte without active material onto the anode layer 16b of the second support strip 14b.

Operations of depositing the separation layers 18a and 18b, formed of electrolyte, are respectively indicated by the arrows 230a, 230b. The electrolyte is deposited in liquid form, preferably over an area equal to that of the cathode layer 16a and the anode layer 16b. A single solidifiable liquid electrolyte may be used for the depositing of the separation layers 18a, 18b on both manufacturing lines 110a, 110b. It may involve in particular solidifiable liquid electrolyte entering in the composition of the underlying cathode layer 16a and anode layer 16b. The electrolyte contains a photoinitiator with which to initiate the solidification of the electrolyte under the effect of light radiation. It may be ultraviolet, visible or near infrared radiation, for example.

The thickness of the electrolyte layers without active material is, for example, of order 10 to 60 μm.

The distance between the first and third depositing head on the one hand, and the distance between the second and fourth depositing head on the other hand, is sufficiently short, and the passage speed of the support strips is sufficiently high for depositing separation layers 18a and 18b before complete solidification of the underlying cathode 16a and anode 16b layers. The solidification of the layers may take place in a few seconds corresponding to a forward motion of the strips along the manufacturing lines 110a, 110b of a few meters.

Initiation the solidification of the separation layers 18a, 18b takes place right after depositing thereof, by a new exposure to light radiation. The strips pass in front of a third UV radiation source 134a and a fourth UV radiation source 134b arranged respectively after the third and fourth depositing head 130a, 130b.

Exposing the separation layers 18a, 18b is indicated by the arrows 234a, 234b. The effect of this exposure is to initiate solidification of the separation layers 18a, 18b.

At the outcome of these operations, the first support strip 14a and the second support strip 14b, provided with the aforementioned layers, again pass by sizing rollers. More precisely it involves a third pair of sizing rollers 136a and a fourth pair of sizing rollers 136b, respectively.

Just like the first and second pair of sizing rollers, the third pair of sizing rollers and the fourth pair of sizing rollers are followed by thickness sensors 138a, 138b. The measurements from these thickness sensors compared to the measurements from the sensors 128a, 128b associated with the first and second sizing rollers serve to set the thickness of the separation layers 18a and 18b and to adjust the separation of the sizing rollers as needed.

Operations of sizing the thickness of the separation layers 18a, 18b are indicated by the arrows 236a and 236b respectively. The final thickness may be included, for example between 10 and 60 μm. Preferably, it may be 30 μm.

After the sizing, the support strips 14a, 14b, respectively provided with layers 16a, 16b comprising active electrode material and separation layers 18a, 18b form half-cells 10a, 10b.

After this operation, the half-cells 10a, 10b in strips reach the pair of assembly rollers 142, already discussed. The half-cells are assembled by placing the respective separation layers 18a, 18b thereof into contact. The assembly may be a direct assembly or an assembly accompanied by interposition of a layer of an additional electrically insulating grid separator film 20, coming from an uncoiling roller 112c. It may involve, for example, a grid of electrically insulating polymer wire. The operation for assembly of the half-cells is indicated with an arrow 242. The interposition of the film 20 must not prevent direct contact between the separation layers 18a and 18b in order to assure a good contact interface between these layers.

Optionally, it is possible to proceed with an operation of depositing a separation layer 18c on the electrically insulating separator film 20, as indicated by the arrow 230c. The electrolyte is deposited in liquid form by a fifth depositing head 130c on the film 20 while passing in front of the fifth depositing head, preferably over a width equal to that of the electrically insulating grid separator film 20 and so as to fully soak the latter. The same liquid electrolyte may be used as for depositing the separation layers 18a, 18b and similarly to the operations these layers underwent, and an initiation of the solidification of the film 20 takes place right after depositing thereof, by exposure to light radiation. The film 20 passes in front of a fifth UV radiation source 134c arranged after the fifth depositing head 130c, in order to be exposed to radiation during an exposure operation indicated by the arrow 234c.

The distance separating the assembly rollers 142 respectively from the third, fourth and fifth radiation sources is sufficiently small and the passage speed of the strips is sufficiently high, that the assembly of the half-cells takes place before complete solidification of the separation layers 18a, 18b and possibly 18c. In that way the solidification continues for several moments after assembly of the cells.

It should be noted that the separation layers 18a, 18b and 18c may each be used alone or in combination with one or another of the two other separation layers. Thus, two layers 18a and 18b together in direct contact, the layers 18a, 18b and 18c alone, the layer 18c in combination with one or the other of the layers 18a and 18b or in combination with both layers 18a and 18b may be used. What is important is to assure both the presence of a separation layer (which could be made up of an arbitrary combination of layers 18a, 18b and 18c) between the cathode 16a and anode 16b layers, and also a close contact between these layers in order to assure a good continuity in the movement of ions between the cathode and anode.

The separation layers may have the same composition or different compositions, but each comprises a solidifiable liquid electrolyte mixture comprising an ion conducting separation liquid electrolyte, a separation monomer or polymer mixture and a polymerization or cross-linking initiator for the first separation monomer or polymer mixture. As with the cathode and anode layers, the presence of monomer or polymer along with the polymerization or cross-linking initiator for this monomer or this polymer assures the solidifiability of the separation layers.

A thickness sensor 144 which follows the assembly rollers 142 serves to measure the thickness of the assembled cell and adjust as needed the separation of the assembly rollers 142.

An electrically insulating film 30 provided by an unwinding roller 160 may be applied to the first support or the second support after assembly of the first half-cell with the second half-cell; and the assembled first half-cell and second half-cell and the electrically insulating film applied to the first support or the second support, so as to insulate themselves from each other, may be coiled around the coiling roller 150. This is particularly advantageous when the batteries are sodium sulfide or lithium sulfide type, since they are electrically charged during manufacturing thereof and it is then preferable to insulate them from each other in order to prevent possible electrical discharges.

After assembly of the half-cells 10a, 10b, the cell 10 goes by a tool 140 for edge cutting. It involves a tool with rotating blades or laser heads. The cutting, indicated on the figure with an arrow 238, is done on the lateral edges of the cell, so as to set the width thereof. It serves to eliminate lateral edges of the support strips 14a, 14b which might not have received active electrode material, and/or electrolyte, in order to only keep a central part where the cell is complete and free of rough edges.

The cell 10, now assembled, is finally coiled on a coiling roller 150. The coiling roller 150 has several functions. A first function is to coil the assembled battery cell. Another function is a driving function. In fact, the rotation of the coiling roller 150 has the effect of exerting traction on the assembled battery cell and consequently on the half-cells, on the support strips and, as applicable, on the electrically insulating grid separator film 20. Thus, the forward motion of the on-strip components along manufacturing lines is assured by rotating the coiling roller.

The uncoiling rollers may be driven and/or braked rollers, or freely rotating rollers. In the case of freely rotating rollers, the uncoiling simply results from the traction exerted by the driving coiling roller 150. When the uncoiling rollers are braked or driven, the braking or driving may be bound to the rotation of the driving coiling roller 150 so as to adjust the tension of the support strips and on-strip components passing along the manufacturing lines.

A driver unit 101 for the apparatus may be provided for coordinating various parameters such as the coiling speed, the tension of the support strips, but also the coating of the support strips or the calendering operations previously described. The driver unit thus controls at least one among the coiling roller, the first coating module, the second coating module, the first rolling module and the second rolling module.

The driver unit controls for example, the driving coiling roller 150 by acting on a speed setting for the drive motor M thereof.

Thus, during a step 248 indicated by an arrow on FIG. 1, the driver unit 101 controls the passage speed of the support strips by the control of the coiling speed of the driving coiling roller 150, and therefore controls the time interval separating the application of two consecutive operations of the manufacturing method at given locations of the support strips.

By controlling the time interval separating (i) the exposures of two liquid layers to radiation initiating solidification of these layers, and (ii) bringing these two layers into contact, a liquid interface between these two layers can be assured with placement thereof into contact occurring before complete respective solidification thereof.

In particular, during step 248 the following steps can be implemented by means of the driver unit 101:
d1) placing the first separation layer (18a) into direct contact with the second separation layer (18b) and controlling (248): a first time interval separating (i) exposing the cathode layer in step a3) and (ii) depositing the first separation layer in step a4), such that the solidification of the cathode layer is not complete at the moment of depositing the first separation layer, and a second time interval separating (i) exposing the anode layer in step b3), and (ii) depositing the second separation layer in step b4) such that the solidification of the anode layer is not complete at the time of depositing the second separation layer, a third time interval separating (i) exposing the first separation layer in step a4) and (ii) placement in contact in step d1) and a fourth time interval separating (i) exposing the second separation layer in step b4) and (ii) placement in contact in step d1), such that the respective solidifications of the first and second separation layers are not complete at the moment of placement in contact in step d1);
d2) placing the first separation layer (18a) into direct contact with the anode layer (16b) and controlling (248): a first time interval separating (i) exposing the cathode layer in step a3) and (ii) depositing the first separation layer in step a4), such that the solidification of the cathode layer is not complete at the moment of depositing the first separation layer, a second time interval separating (i) exposing the first separation layer in step a4) and (ii) placement in contact in step d2) and a third time interval separating (i) exposing the anode layer in step b3) and (ii) placement in contact in step d2), such that the solidification of the first separation layer is not complete at the moment of placement in contact in step d2);
d3) placing the second separation layer (18b) into direct contact with the cathode layer (16a) and controlling (248): a first time interval separating (i) exposing the anode layer in step b3), and (ii) depositing the second separation layer in step b4), such that the solidification of the anode layer is not complete at the time of depositing the second separation layer, a second time interval separating (i) exposing the second separation layer in step b4) and (ii) placement in contact in step d3) and a third time interval separating (i) exposing the cathode layer in step a3) and (ii) placement in contact in step d3), such that the solidification of the second separation layer is not complete at the moment of placement in contact in step d3); and
d4) enclosing the third separation layer (18c) between the cathode layer (16a) and the anode layer (16b) and placing the third separation layer into contact with the cathode layer and the anode layer and controlling (248): a first time interval separating (i) exposing the cathode layer in step a3) and (ii) placement in contact in step d4), a second time interval separating (i) exposing the anode layer in step b3) and (ii) placement in contact in step d4), and a third time interval separating (i) exposing the third separation layer in step c4) and (ii) placement in contact in step d4), such that the respective solidifications of the cathode layer, anode layer and third solidification layer are not yet complete at the moment of placement in contact in step d4).

Preferably, all of the manufacturing apparatus may be installed in a room with an anhydrous atmosphere avoiding any reaction of the still liquid electrolyte with moisture in the air which could lead to a breakdown of the cell.

The various members described with reference to FIG. 1 may be grouped in several independent modules whose positioning and separation on the manufacturing lines may be changed as needed.

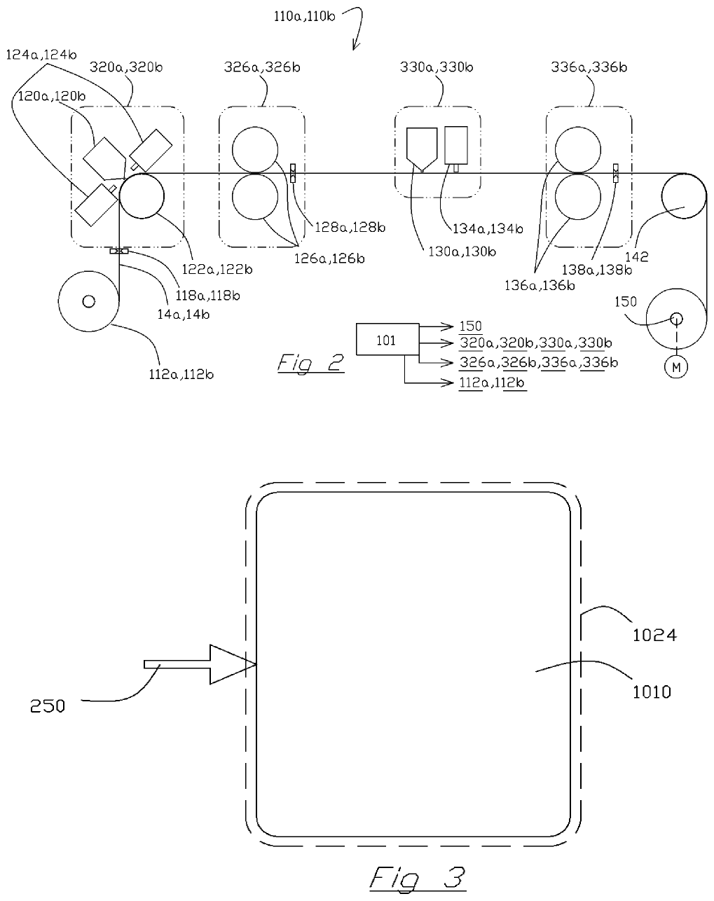

The modules are indicated in FIG. 2 which shows one of the manufacturing lines 110a, 110b corresponding in some way to a half-manufacturing machine for half-cells. Because of the symmetry of the apparatus and the large similarity of the two manufacturing lines, the references for the two manufacturing lines 110a, 110b are shown on the same figure, FIG. 2. It is understood that one manufacturing line according to FIG. 2 may be used for manufacturing the half-cell comprising a cathode and for the half-cell comprising an anode.

Between the uncoiling roller 112a, 112b and the assembly rollers 142, only one of which is visible in FIG. 2, the strip passes through several modules. In order, there are a first coating module 320a, 320b, a first rolling module 326a, 326b, a second coating module 330a, 330b and a second rolling module 336a, 336b. The first coating module 320a, 320b comprises the first coating head 120a or the second coating head 120b described with reference to FIG. 1 and also the radiation sources 124a, 124b which are associated with them. It may be noted that the radiation source associated with the coating head for the first module is split. The use of a single radiation source is also conceivable.

The second coating module 330a, 330b comprises the third coating head 130a or the fourth coating head 130b described with reference to FIG. 1 and the radiation source 134a, 134b which is associated with it.

The first rolling module 326a, 326b comprises the sizing rollers 126a, 126b intended to set the thickness of the anode layer or the cathode layer, according to the manufacturing line involved. The first rolling module also comprises a thickness sensor 128a, 128b placed after the sizing rollers, in order to measure the thickness of the half-cell during manufacturing at the output of the sizing rollers.

The second rolling module 336a, 336b comprises sizing rollers 136a, 136b intended to set the thickness of the half-cells during manufacturing after depositing an electrolyte layer without active material. Like the first rolling module, the second rolling module comprises a thickness sensor 138a, 138b place just after the sizing rollers. The thickness sensor serves to measure the thickness of the half-cells immediately before the assembly thereof.

The various modules 320a, 320b, 326a, 326b, 330a, 330b, 336a, 336b, and also the uncoiling rollers 112a, 112b and the coiling roller 150 are connected to a driver unit 101, shown schematically, which serves to synchronize the various members.

As previously indicated, an implementation of the invention is possible by covering only one of the anode layer and the cathode layer with an electrolyte layer without active material. In this case, one of the second coating modules 330a, 330b and one of the second rolling modules 336a, 336b may be omitted.

The coiling roller 150 is a driving roller moved by a motor M indicated symbolically.

Some number of optional members described with reference to FIG. 1 are not shown in FIG. 2 for reasons of simplification.

FIG. 3 shows a formatted battery cell 1010. The formatted cell is obtained from the cell 10, in strip, from FIG. 1 at the end of the formatting operation indicated symbolically with reference 250. This operation comprises in particular, in the example shown by FIG. 3, the cutting of the peripheral edges of the formatted cell 1010. The cell is cut, from side to side, meaning through the entire thickness of the cell, which is of order a few hundreds of microns.

The cutting may advantageously be done on a laser cutting table. Cutting by knives is also conceivable.

In the example shown in FIG. 3, the formatted cell 1010 is shown with rectangular shape principal surfaces and with rounded corners. Cutting according to another, more complex pattern is entirely possible which may improve the ability to house the cell in a space dedicated to apparatus, for example.

Since the cell does not contain liquid, and in particular liquid electrolyte, the cutting operation does not require specific precautions. The electrically conducting supports serving as current collector remain electrically insulated, meaning insulated against conduction by an electron current because of the presence of solid electrolyte layers. In this respect, the cutting may preferably be done after complete solidification of the layers.

In the implementation example from FIG. 3, the peripheral edge of the formatted cell 1010, resulting from cutting, is covered with an electrically insulating protective coating 1024, for example varnish. This varnish may be reinforced with glass or basalt fibers, for example. The protective coating may be preferably formed after having stacked a plurality of identical formatted cells 1010 so as to cover the sides of the stack.

FIG. 4 shows a part of a stack of a plurality of formatted cells 1011, 1012, 1013, 1014, 1015, identical to the cell 1010 visible in FIG. 3. Each of the formatted cells may be cut into a strip battery cell 10 such as discussed with reference to FIG. 1. The stacking from FIG. 4 makes up a storage battery 1000.

For several formatted cells, FIG. 4 shows the first and second electrically conducting supports 14a, 14b, the cathode layer 16a and the anode layer 16b, the first separation layer 18a and the second separation layer 18b.

The layers making up each formatted cell are substantially identical and indicated with the same references. However, it can be seen that the first electrically conducting support 14a of the first formatted cell 1011 of the stack and the second electrically conducting support 14b of the last formatted cell 1015 at the stack are thicker than the other conducting supports. These thicker conducting supports are formed of several conducting sub-layers. They have a greater mechanical strength, which is suited to the function thereof as outer envelope of the battery 1000. The thicker conducting supports for the first and last cell of the stack also constitute exterior electrical connection terminals for the battery 1000.

In the stack, the cathode and anode layers, meaning the positive and negative electrodes of the various formatted cells, are alternated. Each cell of the stack is thus connected in series with the other cells of the stack via conducting supports 14a, 14b which form the current collectors thereof. The voltage at the terminals of the conducting layers 14a, 14b of the end cells 1011 1015 is equal to the sum of the voltage of the individual cells and corresponds to the battery voltage 1000.

It should be specified that other connections of formatted cells are possible and in particular connections in parallel, or series/parallel or parallel/series combinations. In this case, additional electrical conductors may be provided for connecting the current collectors of the individual formatted cells.

The embodiment detailed above is of roll-to-roll type implementing a continuous passage method. Alternatively, it is possible to implement a sequential manufacturing by manufacturing of individual plates. The handling of the plates may be done by conventional methods, for example by robotic arms provided with grasping means. In this case, control of the time is assured by control the moments of handling the plates.

The present invention can in no way be limited to the embodiment disclosed above, which could undergo modifications without thereby going outside the scope of the invention.

1. A manufacturing method for an energy storage cell in electrochemical form, comprising the steps of:
forming a first half-cell, comprising the following steps a1), a2), a3):
a1) providing a first electrically conducting support;
a2) depositing, on a surface of the first electrically conducting support, a cathode layer in a pasty state, comprising an active cathode material, carbonaceous electrically conducting fillers, a first liquid ion conducting electrolyte mixture, a first monomer or polymer mixture and a first polymerization or cross-linking initiator for the first monomer or polymer mixture; and
a3) exposing the cathode layer in a pasty state by means of a first radiation suited to the first polymerization or cross-linking initiator for the first monomer mixture, so as to initiate a solidification of the cathode layer;
forming a second half-cell, comprising the following steps b1), b2), b3):
b1) providing a second electrically conducting support;
b2) depositing, on a surface of the second electrically conducting support, an anode layer in a pasty state, comprising an active anode material, carbonaceous electrically conducting fillers, a second liquid ion conducting electrolyte mixture, a second monomer or polymer mixture and a second polymerization or cross-linking initiator for the second monomer or polymer mixture; and
b3) exposing the anode layer in a pasty state by means of a second radiation suited to the second polymerization or cross-linking initiator for the second monomer mixture, so as to initiate a solidification of the anode layer;
implementing at least one of the following steps a4), b4) and c4):
a4) depositing and exposing, on the exposed cathode layer before complete solidification of the exposed cathode layer, a first separation layer formed of a first separation mixture in a liquid state, comprising a first ion conducting separation liquid electrolyte mixture, a first separation monomer or polymer mixture and a first polymerization or cross-linking initiator for the first separation monomer or polymer mixture; and
c4) depositing and exposing, on an electrically insulating grid film, a third separation layer formed of a third separation mixture in a liquid state, comprising a third ion conducting separation liquid electrolyte mixture, a third separation monomer or polymer mixture and a third polymerization or cross-linking initiator for the third separation monomer or polymer mixture;
b4) depositing and exposing, on the exposed anode layer before complete solidification of the exposed anode layer, a second separation layer formed of a second separation mixture in a liquid state, comprising a second ion conducting separation liquid electrolyte mixture, a second separation monomer or polymer mixture and a second polymerization or cross-linking initiator for the second separation monomer or polymer mixture; and
where the exposures for steps a4), b4), and c4) were implemented by means of third radiations, suited for the polymerization or cross-linking initiators for the respective separation monomer or polymer mixtures and suited for initiating solidification of the first, second and third separation layers;
assembling the first half-cell and the second half-cell by interposing between the two half-cells, at least one of the separation layers from steps a4), b4) and c4), where the assembly comprises one of the following steps d1), d2), d3) and d4):
d1) bringing the exposed first separation layer into direct contact with the exposed second separation layer,
d2) bringing the exposed first separation layer into direct contact with the exposed anode layer; and
d3) bringing the exposed second separation layer into direct contact with the exposed cathode layer; and
d4) enclosing the third exposed separation layer between the exposed cathode layer and the exposed anode layer, in which steps d1), d2), d3) and d4) the respective solidifications of the layers brought into contact are incomplete.

2. The method according to claim 1, comprising:
sizing of the thickness of the cathode layer, respectively of the anode layer, before depositing the first separation layer, respectively before depositing the second separation layer; and/or
sizing of the thickness of the first separation layer, respectively of the second separation layer before assembling the half-cells.

3. The method according to claim 1, wherein the first support and the second support are respectively a first support strip and a second support strip and wherein:
supplying the first support and supplying the second support respectively comprises uncoiling the first support strip and uncoiling the second support strip respectively from a first uncoiling roller and a second uncoiling roller.

4. The method according to claim 1, comprising the steps of:
applying electrically insulating film to the first support or the second support after assembling the first half-cell and the second half-cell; and
coiling, around the coiling roller, the assembled first half-cell and second half-cell and the electrically insulating film applied to the first support or the second support.

5. The method according to claim 3, wherein depositing the cathode layer, and depositing the anode layer may take place continuously by passage of the first strip and the second strip respectively in front of a first depositing head for the first mixture and a second depositing head for the second mixture.

6. The method according to claim 3, wherein:
depositing the first separation layer and depositing the second separation layer take place continuously by passage of the first strip and the second strip respectively in front of a third electrolyte depositing head and in front of a fourth electrolyte depositing head.

7. The method according to claim 3, wherein:
exposing the cathode layer and exposing the anode layer take place by passage respectively of the first strip and the second strip respectively in front of at least one first source of radiation and at least one second source of radiation.

8. The method according to claim 3, wherein, exposing the first separation layer and exposing the second separation layer takes place by passage respectively of the first strip and of the second strip in front of a third radiation source and a fourth radiation source.

9. The method according to claim 2, wherein the first support and the second support are respectively a first support strip and a second support strip and wherein:
sizing of the thickness of the cathode layer, respectively sizing of the anode layer, takes place by passage of the first support strip, provided with the cathode layer respectively of the second support strip provided with the anode layer through a first pair of sizing rollers and a second pair of sizing rollers.

10. The method according to claim 2, wherein sizing of the thickness of the first separation layer, respectively sizing of the second separation layer, takes place by passage of the first half-cell, respectively of the second half-cell, through a third pair of sizing rollers and a fourth pair of sizing rollers.

11. The method according to claim 1, comprising implementation of steps a4) and b4) and comprising placing an electrically insulating grid separator film between the separation layers during assembly of the first half-cell and the second half-cell.

12. The method according to claim 1, comprising, subsequent to assembly of the half-cells, an operation of formatting the cell comprising cutting of the battery cell into formatted cells.

13. The method according to claim 12, comprising placing a protective coating of electrically insulating material over at least one side edge of the formatted battery cell.

14. The method according to claim 1, wherein the first liquid electrolyte mixture of the cathode layer, the second liquid electrolyte mixture of the anode layer, the first liquid electrolyte mixture of the first separation layer, the second liquid electrolyte mixture of the second separation layer and the third liquid electrolyte mixture of the third separation layer are identical.

15. A method for manufacturing a battery comprising the manufacturing a plurality of battery cells according to the method claim 11, and the formation of a stack of battery cells, where the formation of the stack comprises placing a free conducting surface of the first support of a formatted battery cell into contact with a free conducting surface of the second support of a following formatted battery cell of the stack.

16. An apparatus for manufacturing a battery cell according to claim 1, comprising:
a first manufacturing line for manufacturing a first half-cell;
a second manufacturing line for manufacturing a second half-cell;
a pair of assembly rollers for the assembly of the first half-cell formed on the first manufacturing line and a second half-cell formed on the second manufacturing line;
a battery-cell coiling roller placed downstream from the pair of assembly rollers;
wherein at least one of the first manufacturing line and the second manufacturing line comprise:
an uncoiling roller for uncoiling a support strip; and, in order between the uncoiling roller and the pair of assembly rollers;
a first coating module for forming a cathode layer, respectively an anode layer;
a first rolling module;
a second coating module for forming a separation layer; and
a second rolling module,
wherein the first and second rolling module comprise respectively a pair of sizing rollers and a thickness sensor associated respectively with the pair of sizing rulers, and
wherein the first coating module and the second coating module respectively comprise a depositing head and at least one radiation source associated with the depositing head.

17. The apparatus according to claim 16 wherein the coiling roller is a driving roller.

18. (canceled)

19. The apparatus according to claim 16, wherein the uncoiling roller is a braking roller.

20. (canceled)

21. (canceled)

22. The apparatus according to claim 16, comprising a driver unit for at least one among the coiling roller, the first coating module, the second coating module, the first rolling module and the second rolling module.

23. The apparatus according to claim 16, wherein the depositing head of the first coating module is a cathode layer depositing head, depositing head of the second coding module is an anode layer depositing head; at least one radiation source is associated with the cathode layer depositing head and at least one radiation source is associated with the anode layer depositing head.
